(19) United States
(12) Patent Application Publication
(10) Pub. No.: US 2021/0135936 A1
(43) Pub. Date: May 6, 2021

(54) Restoring Settings of Customer Premises Equipment

(71) Applicant: CenturyLink Intellectual Property LLC, Broomfield, CO (US)

(72) Inventors: Steven M. Casey, Littleton, CO (US); Stephen Rikard, Olive Branch, MS (US)

(21) Appl. No.: 16/797,262

(22) Filed: Feb. 21, 2020

Related U.S. Application Data
(60) Provisional application No. 62/930,963, filed on Nov. 5, 2019.

(51) Int. Cl. H04L 12/24; H04L 12/28

(52) U.S. Cl. CPC H04L 41/0806; H04L 41/0813; H04L 12/2834; H04L 12/2898; H04L 41/0856

(57) ABSTRACT

Novel tools and techniques are provided for implementing configuration data and settings on customer premises equipment (“CPE”), and, more particularly, to methods, systems, and apparatuses for implementing storage, retrieval, and transfer of configuration data and settings in response to receiving a request to reset the CPE. In operation, the CPE might set one or more configuration settings associated with a user and/or a customer premises on the CPE. Next, the CPE might receive a request to reset the CPE. In response to receiving the request to reset the CPE, the CPE might store one or more configuration settings. The CPE may then reset. In response to resetting the CPE, the CPE might retrieve the one or more configuration settings and configure the CPE with the one or more configuration settings associated with the at least one of the user or the customer premises.

### CROSS-REFERENCES TO RELATED APPLICATIONS

This application claims priority to U.S. Patent Application Ser. No. 62/930,963 (the “'963 Application”), filed Nov. 5, 2019 by Steven M. Casey et al. (attorney docket no. 1553-US-P1), entitled, “Restoring Settings of Customer Premises Equipment,” the disclosure of which is incorporated herein by reference in its entirety for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for implementing configuration data and settings on customer premises equipment (“CPE”), and, more particularly, to methods, systems, and apparatuses for implementing storage, retrieval, and transfer of configuration data and settings in response to receiving a request to reset the CPE.

### BACKGROUND

Currently, the configuration of customer premises equipment (“CPE”) requires manual setup and manual entry of data crucial to a subscriber's service. There is no way to automatically restore user or technician configured data when a user presses a factory reset button or after the CPE experiences an error. A user must manually setup and reenter data after a factory reset button is pressed or the CPE experiences an error. The data that must be entered manually includes, but is not limited to, login credentials, wireless and security settings, or domain name server addresses, and/or the like. Small typographical errors may affect crucial information such as domain names or addresses for servers (e.g., outgoing or incoming mail servers, domain name servers, proxy servers), rendering the CPE partially or completely non-functional until the error is corrected.

Hence, there is a need for more robust and scalable solutions for implementing configuration data and settings on customer premises equipment (“CPE”), and, more particularly, to methods, systems, and apparatuses for implementing storage, retrieval, and transfer of configuration data and settings in response to receiving a request to reset the CPE.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a schematic diagram illustrating a system for implementing configuration data and settings on customer premises equipment, in accordance with various embodiments.

FIG. 2 is a schematic diagram illustrating another system for implementing configuration data and settings on customer premises equipment, in accordance with various embodiments.

FIG. 3 is a schematic diagram illustrating an additional system for implementing configuration data and settings on customer premises equipment, in accordance with various embodiments.

FIG. 4 is a schematic diagram illustrating yet another system for implementing configuration data and settings on customer premises equipment, in accordance with various embodiments

FIGS. 5A and 5B are flow diagrams illustrating a method for implementing configuration data and settings on customer premises equipment, in accordance with various embodiments.

FIG. 6 is an additional flow diagram illustrating a method for implementing configuration data and settings on customer premises equipment, in accordance with various embodiments.

FIG. 7 is a block diagram illustrating an exemplary computer or system hardware architecture, in accordance with various embodiments.

FIG. 8 is a block diagram illustrating a networked system of computers, computing systems, or system hardware architecture, which can be used in accordance with various embodiments.

### DETAILED DESCRIPTION OF CERTAIN EMBODIMENTS

### Overview

Various embodiments provide tools and techniques for implementing configuration data and settings on customer premises equipment (“CPE”), and, more particularly, to methods, systems, and apparatuses for implementing storage, retrieval, and transfer of configuration data and settings in response to receiving a request to reset the CPE. Throughout the specification, CPE might also be referred to as a customer premises device.

In various embodiments, a method might optionally include setting, on a customer premises device, one or more configuration settings associated with at least one of a user or a customer premises. The method might additionally include receiving, with a customer premises device, a request to reset the customer premises device; in response to receiving the request to reset the customer premises device, storing, with the customer premises device, one or more configuration settings associated with the at least one of a user or a customer premises; resetting, with the customer premises device, the customer premises device; in response to resetting the customer premises device, retrieving, with the customer premises device, one or more configuration settings associated with at least one of a user or a customer premises, wherein the one or more configuration settings associated with at least one of a user or a customer premises are different from one or more factory settings associated with the customer premises device; and configuring, with the customer premises device, the customer premises device with the one or more configuration settings associated with the at least one of the user or the customer premises.

In sum, the various embodiments described above improve conventional systems by providing novel ways to restore and transfer configuration settings associated with at least one of a user and/or a customer premises. The various embodiments provide methods to save and back up crucial CPE configuration data or settings associated with a user and/or a customer premises with little or no user intervention. Further, the various embodiments provide ways to automatically reconfigure a customer premises device with configuration data or settings associated with the at least one of the user or the customer premises.

It is important to note that the configuration settings associated with at least one of a user and/or a customer premises described in this disclosure are different from factory reset configuration settings that are typically provided as an option for CPE. The factory reset configuration settings are factory condition settings, as the name implies. Factory reset configuration settings contain no settings entered by a user or technician, and/or the like. Further, factory reset settings are not associated with at least one of a user and/or a customer premises. The embodiments described herein save user-entered or technician-entered configuration data (configuration settings associated with at least one of a user and/or a customer premises) for CPE. Restoring one or more configuration settings associated with at least one of a user and/or a customer premises will cause the CPE to be placed back into a state where it can perform as configured by a user or technician, and/or the like.

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

Various embodiments described herein, while embodying (in some cases) software products, computer-performed methods, and/or computer systems, represent tangible, concrete improvements to existing technological areas, including, without limitation, CPE technology, computer technology, and/or the like. Each embodiment seeks to solve restoring configuration settings associated with at least one of a user and/or customer premises on a CPE. In other words, the configuration settings that are unique to a particular user and/or customer premises are restored on the CPE. Conventional computer technology does not allow for restoring configuration settings associated with at least one of a user and/or customer premises on a CPE.

In order to facilitate restoring and transferring configuration settings on a CPE (e.g., a modem, an optical network terminal, a set-top box, a gateway, a media player, a camera, a sensor, or a thermostat, and/or the like), various embodiments provide for, in response to receiving the request to reset the customer premises device, storing, with the customer premises device, one or more configuration settings associated with the at least one of a user or a customer premises and, in response to resetting the customer premises device, retrieving, with the customer premises device, one or more configuration settings associated with at least one of a user or a customer premises. The one or more configuration settings associated with a user and/or customer premises may be unique to a particular user, configured by a user, or unique to the customer premises, and/or the like.

To the extent any abstract concepts are present in the various embodiments, those concepts can be implemented as described herein by devices, software, systems, and methods that involve specific novel functionality (e.g., steps or operations), such as, in response to receiving the request to reset the customer premises device, storing, with the customer premises device, one or more configuration settings associated with the at least one of a user or a customer premises and using the one or more configuration settings that have been stored to automatically reconfigure the customer premises device, which optimizes the reconfiguration of a customer premises device, and/or the like, to name a few examples, that extend beyond mere conventional computer processing operations. These functionalities can produce tangible results outside of the implementing computer system, including, merely by way of example, automatically reconfiguring CPE with configuration settings and/or data associated with a user or a customer premises, or both.

In an aspect, a method might optionally comprise setting, on a customer premises device, one or more configuration settings associated with at least one of a user or a customer premises. The method might additionally include receiving, with a customer premises device, a request to reset the customer premises device; in response to receiving the request to reset the customer premises device, storing, with the customer premises device, one or more configuration settings associated with the at least one of a user or a customer premises; resetting, with the customer premises device, the customer premises device; in response to resetting the customer premises device, retrieving, with the customer premises device, the one or more configuration settings associated with at least one of a user or a customer premises, wherein the one or more configuration settings associated with at least one of a user or a customer premises are different from one or more factory settings associated with the customer premises device; and configuring, with the customer premises device, the customer premises device with the one or more configuration settings associated with the at least one of the user or the customer premises.

In some embodiments, the customer premises device may comprise at least one of a modem, an optical network terminal, a set-top box, a gateway device, a media player, a gaming console, a camera, a sensor, a thermostat, a desktop computer, or a laptop computer, and/or the like.

The one or more configuration settings may be unique to a particular user and/or customer premises, set by a user and/or technician, and/or the like. The one or more configuration settings associated with at least one of a user or a customer premises might include, but are not limited to, at least one of one or more local area network settings, one or more wide area network settings, one or more service set identifiers, one or more login credentials, one or more Internet protocol (“IP”) addresses, one or more domain names, one or more security settings, one or more remote management settings, one or more encryption types, one or more frequency settings, one or more blocked addresses, one or more permitted addresses, one or more calibration settings, or one or more display settings, and/or the like.

According to some embodiments, the one or more configuration settings associated with the at least one of the user or the customer premises may be stored on and retrieved from at least one of a local storage device associated with the customer premises device, a remote (or local) storage associated with a user device located at the customer premises, or a remote storage device located in a service provider network.

Merely by way of example, in some embodiments, the one or more configuration settings may be stored with at least one of a date stamp indicating a date when the one or more configuration settings were stored or a time stamp indicating a time when the one or more configuration settings were stored. Additionally and/or alternatively, the one or more configuration settings may be stored with a device identifier identifying the customer premises device associated with the one or more configuration settings.

In some cases, the one or more configuration settings associated with the at least one of the user or the customer premises may be periodically (e.g., hourly, daily, weekly, or monthly, etc.) stored on a local storage device or remote storage device.

In various embodiments, the request to reset the customer premises device may be received via a reset signal generated by a hardware button located on the customer premises device. The hardware button may be a factory reset button located on the customer premises device.

In some instances, the method might include determining, with the customer premises device, whether an outage in a network has occurred. The network may be a service provider network. Based on a determination that an outage in the network has occurred, the method might include storing, with the customer premises device, the one or more configuration settings associated with the at least one of the user or the customer premises.

In some embodiments, the method might further include determining, with the customer premises device, whether the one or more configuration settings associated with the at least one of the user or the customer premises have been changed. The one or more configuration settings may be changed by a user or a technician, or automatically by the customer premises device, and/or the like. Based on a determination that the one or more configuration settings associated with the at least one of the user or the customer premises have been changed, the method might include storing, with the customer premises device, the one or more changed configuration settings associated with the at least one of the user or the customer premises.

In some embodiments, the method might further comprise in response to receiving the request to reset the customer premises device, checking for a network connection between the customer premises device and a service provider network; based on a determination that the network connection exists between the customer premises device and the service provider network, storing the one or more configuration settings in a remote storage located in the service provider network; and based on a determination that the network connection does not exist between the customer premises device and the service provider network, storing the one or more configuration settings in a local storage of the customer premises device.

In additional embodiments, the method might include in response to receiving the request to reset the customer premises device, displaying, with the customer premises device, the one or more configuration settings associated with the at least one of the user or the customer premises; receiving, with the customer premises device, a selection from the user of the one or more configuration settings; and configuring, with the customer premises device, the customer premises device with the one or more configuration settings selected by the user. The one or more configuration may be displayed in a list. The list may include, without limitation, at least one of one or more most recent configuration setting, one or more prior configuration settings, or one or more factory default settings, and/or the like.

In another aspect, an apparatus might comprise at least one processor; and a non-transitory computer readable medium communicatively coupled to the at least one processor. The non-transitory computer readable medium might have stored thereon computer software comprising a set of instructions that, when executed by the at least one processor, causes the apparatus to: receive a request to reset a customer premises device; in response to receiving the request to reset the customer premises device, store one or more configuration settings associated with the at least one of a user or a customer premises; reset the customer premises device; in response to resetting the customer premises device, retrieving one or more configuration settings associated with at least one of a user or a customer premises, wherein the one or more settings associated with at least one of a user or a customer premises are different from one or more factory settings associated with the customer premises device; and configure the customer premises device with the one or more configuration settings associated with the at least one of the user or the customer premises.

According to some embodiments, the apparatus and the customer premises device may be the same device. Alternatively, the apparatus and the customer premises device may be different devices. In some embodiments, the customer premises device may comprise at least one of a modem, an optical network terminal, a set-top box, a gateway device, a media player, a gaming console, a camera, a sensor, a thermostat, a desktop computer, or a laptop computer, and/or the like.

In various embodiments, the one or more configuration settings might include at least one of one or more local area network settings, one or more wide area network settings, one or more service set identifiers, one or more login credentials, one or more Internet protocol (“IP”) addresses, one or more domain names, one or more security settings, one or more remote management settings, one or more encryption types, one or more frequency settings, one or more blocked addresses, one or more permitted addresses, one or more calibration settings, or one or more display settings, and/or the like. Additionally, the one or more configuration settings associated with the at least one of the user or the customer premises may be stored on and retrieved from at least one of a local storage device associated with the customer premises device, a remote storage device (or a local storage device) associated with a device located at the customer premises, or a remote storage device located in a service provider network, and/or the like.

In yet another aspect, a system might comprise a customer premises device. The customer premises device might comprise at least one first processor and a first non-transitory computer readable medium communicatively coupled to the at least one first processor. The first non-transitory computer readable medium might have stored thereon computer software comprising a first set of instructions that, when executed by the at least one first processor, causes the first customer premises device to: receive a request to reset a customer premises device; in response to receiving the request to reset the customer premises device, store one or more configuration settings associated with the at least one of a user or a customer premises; reset the customer premises device; in response to resetting the customer premises device, retrieving one or more configuration settings associated with at least one of a user or a customer premises, wherein the one or more settings associated with at least one of a user or a customer premises are different from one or more factory settings associated with the customer premises device; and configure the customer premises device with the one or more configuration settings associated with the at least one of the user or the customer premises.

In some embodiments, the customer premises device may comprise at least one of a modem, an optical network terminal, a set-top box, a gateway device, a media player, a gaming console, a camera, a sensor, a thermostat, a desktop computer, or a laptop computer, and/or the like.

In various embodiments, the one or more configuration settings might include at least one of one or more local area network settings, one or more wide area network settings, one or more service set identifiers, one or more login credentials, one or more Internet protocol (“IP”) addresses, one or more domain names, one or more security settings, one or more remote management settings, one or more encryption types, one or more frequency settings, one or more blocked addresses, one or more permitted addresses, one or more calibration settings, or one or more display settings, and/or the like. Additionally, the one or more configuration settings associated with the at least one of the user or the customer premises may be stored on and retrieved from at least one of a local storage device associated with the customer premises device, a remote storage device (or a local storage device) associated with a device located at the customer premises, or a remote storage device located in a service provider network, and/or the like.

Various modifications and additions can be made to the embodiments discussed without departing from the scope of the invention. For example, while the embodiments described above refer to particular features, the scope of this invention also includes embodiments having different combination of features and embodiments that do not include all of the above described features.

### Specific Exemplary Embodiments

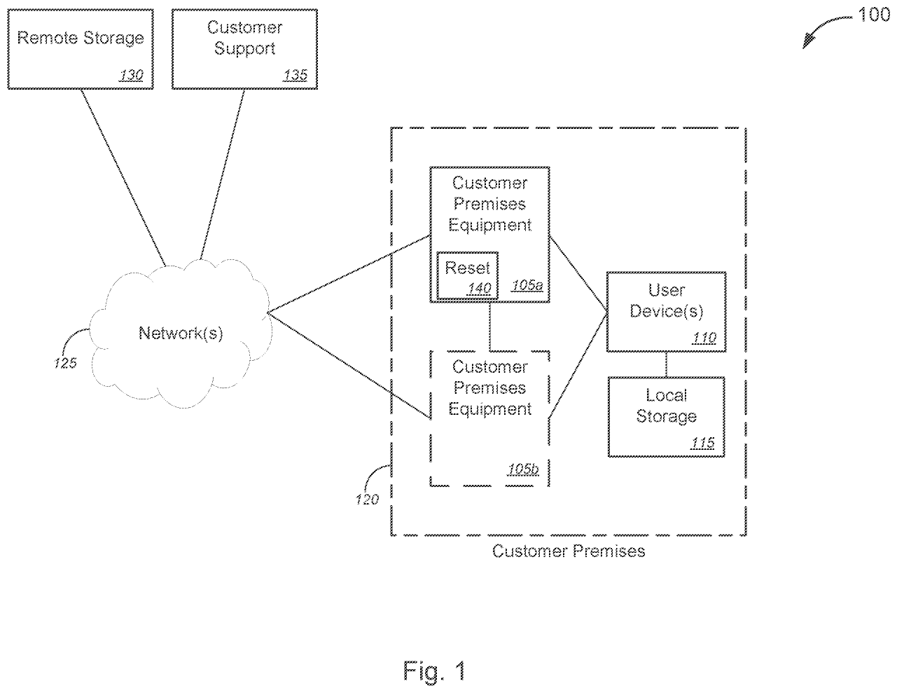

We now turn to the embodiments as illustrated by the drawings. FIGS. 1-8 illustrate some of the features of the method, system, and apparatus for implementing configuration data and settings on customer premises equipment (“CPE”), and, more particularly, to methods, systems, and apparatuses for implementing storage, retrieval, and transfer of configuration data and settings in response to receiving a request to reset the CPE. The methods, systems, and apparatuses illustrated by FIGS. 1-8 refer to examples of different embodiments that include various components and steps, which can be considered alternatives or which can be used in conjunction with one another in the various embodiments. The description of the illustrated methods, systems, and apparatuses shown in FIGS. 1-8 is provided for purposes of illustration and should not be considered to limit the scope of the different embodiments.

With reference to the figures, FIG. 1 is a schematic diagram illustrating a system 100 for implementing configuration data and settings on customer premises equipment (“CPE”) 105, in accordance with various embodiments.

In the non-limiting embodiment of FIG. 1, system 100 might include one or more CPEs (or one or more customer premises devices) 105a and 105b (collectively, “CPE 105” or “CPEs 105”) and one or more user devices 110, each of which (or which collectively) might comprise a local storage device 115. Local storage device 115 may also be located in CPE 105. In some cases, local storage device 115 might be integrated within CPE 105 and/or user device(s) 110. In other cases, the local storage device 115 might be external to CPE 105 and/or user device(s) 110. System 100, according to some embodiments, might further include remote storage device 130 and customer support system/service provider device 135.

In some embodiments, the CPE 105 might include, but is not limited to, one of a modem, an optical network terminal, a set-top box (“STB”), a gateway, a media player, a gaming console, a camera, a sensor, a thermostat, a desktop computer, or a laptop computer, and/or the like. The modem might include at least one of a digital subscriber line modem, a G.fast modem, or a cable modem, and/or the like. The set-top box might include an internet protocol television set-top box, or an over-the-top set-top box, and/or the like. The gateway might include at least one of a residential gateway, business gateway, a pay-per-view gateway, or a security gateway, and/or the like. The sensor may include at least one of window sensors or door sensors, motion detection sensors, or heat sensors, and/or the like.

In some embodiments, CPE 105 might further include a hardware button 140. The hardware button 140 might be a reset button. When a user presses the hardware button 140, the hardware button 140 may cause the CPE 105 to reset. The hardware button 140 may be a factory reset button that causes the CPE 105 to reset to factory configuration settings when a user presses the hardware button 140.

In some cases, hardware button 140 may instead be implemented via software. For example, the hardware button 140 may be a button located on a screen of the CPE 105 and/or user device 110. When a user interacts with the software reset button, the CPE 105 be reset to factory configuration settings.

In some embodiments, the user device(s) 110 might each include, without limitation, one of a laptop computer, a tablet computer, a desktop computer, a smart phone, a mobile phone, a personal digital assistant, a remote control device, a gaming console, a set-top box, a media player, a portable gaming device, a camera, a sensor, or a thermostat, and/or the like.

The CPE 105 might communicatively couple to each of the one or more user devices 110 and/or the local storage device 115 via a wireless connection and/or a wired connection. Each of the one or more user devices 110 might communicatively couple to the local storage device 115, either via wireless connection and/or via wired connection. In some cases, the CPE 105 might be paired, synced, or synchronized with the one or more user devices 110. Additionally and/or alternatively CPE 105a might be communicatively coupled to CPE 105b via a wireless connection and/or via a wired connection.

In some cases, the CPE 105, the one or more user device(s) 110, and the local storage device 115 may be disposed within a customer premises 120, which might be one of a single family house, a multi-dwelling unit (“MDU”) within a multi-dwelling complex (including, but not limited to, an apartment building, an apartment complex, a condominium complex, a townhouse complex, a mixed-use building, etc.), a motel, an inn, a hotel, an office building or complex, a commercial building or complex, or an industrial building or complex, and/or the like.

System 100 might further include one or more remote storage devices 130 and/or one or more customer support systems/service provider devices 135 that might communicatively couple to the CPE 105 via one or more networks 125. The customer support systems might include, without limitation, at least one of a laptop, a computer, or a server computer, and/or the like. The one or more networks 125 may be a service provider network or a local area network, and/or the like.

In operation, the CPE 105, user device(s) 110, a user, and/or a technician might set one or more configuration settings associated with at least one of a user or a customer premises 120 on CPE 105. The configuration settings associated with at least one of a user or a customer premises 120 are unique to at least one of a user or a customer premises 120 and are different from one or more factory configuration settings. Factory configuration settings are settings that the CPE had when it was first manufactured and are not unique to a user or a customer premises 120.

The one or more configuration settings or data associated with at least one of a user or a customer premises 120 might include, but are not limited to, one or more local area network settings, one or more wide area network settings, one or more service set identifiers, one or more login credentials (e.g., login name, password, email address, etc.), one or more Internet protocol (“IP”) addresses, one or more domain names, one or more security settings, one or more remote management settings, one or more encryption types, one or more frequency settings (e.g., bandwidth settings, frequency agility settings, etc.), one or more blocked addresses (e.g., website addresses, media access control addresses, etc.), one or more permitted addresses (e.g., website addresses, media access control addresses, etc.), one or more calibration settings (e.g., calibration settings of a television, calibration settings of modem, etc.), one or more display settings (e.g., display settings of television, etc.), or one or more temperature settings, and/or the like.

The one or more configuration settings may be set manually by a user of the CPE 105, may be set manually by a technician setting up or servicing CPE 105, or may be set automatically by the CPE 105 or user device(s) 110. The one or more configuration settings may be unique to the user or customer premises 120.

Next, the CPE 105 or user device(s) 110 might receive a request to reset the CPE 105. In some embodiments, the request to reset the CPE 105 may be received from a user of the CPE 105 or a technician servicing the CPE 105. The request to reset the CPE 105 may be received via hardware button 140 (which may be a reset button or a factory reset button). Alternatively, the request to reset the CPE 105 may be received via user device 110. The reset button may also be displayed via a software button on the CPE 105. The software button may be a factory reset button displayed on the CPE 105.

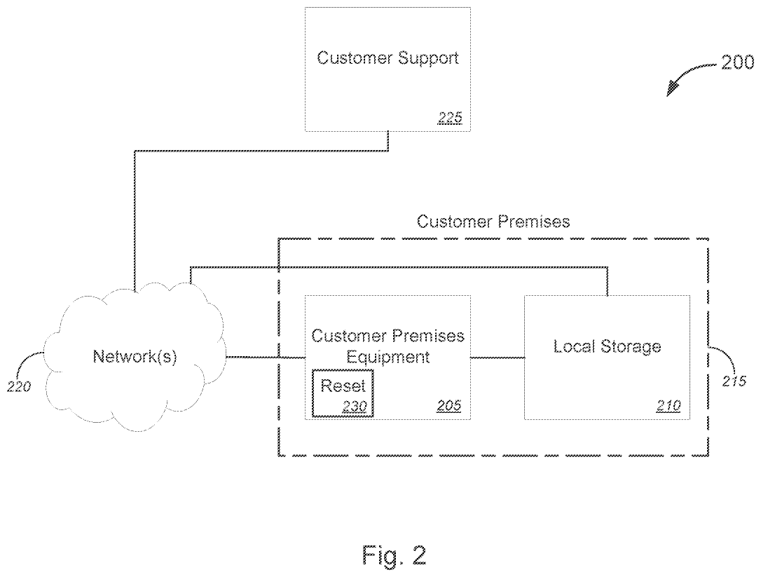

In response to the request to reset the CPE 105, the CPE 105 or user device(s) 110 may then store the one or more configuration settings associated with at least one of the user or the customer premises 120. The CPE 105 or user device(s) 110 may store the configuration settings locally or remotely in local storage device 115 or remote storage device 130, respectively. The storage process will be further described below with respect to FIGS. 2-4.

Thus, if a user or technician presses the reset button 140, and the CPE 105 is reset, the current one or more configuration settings associated with at least one of the user or the customer premises 120 of the CPE 105 are saved for future use by the CPE 105.

Additionally and/or alternatively, CPE 105 might determine that an outage has occurred in network 125. In response to the detection that the outage has occurred in network 125, the CPE 105 or user device(s) 110 may then store the one or more configuration settings associated with at least one of the user or the customer premises 120. The CPE 105 or user device(s) 110 may store the configuration settings locally or remotely in local storage device 115 or remote storage device 130, respectively.

In some cases, CPE 105 and/or user device 110, in response to receiving the request to reset the CPE 105, might check for a network connection between the CPE 105 and a network 125. Based on a determination that the network connection exists between the CPE 105 and the network 125, the CPE 105 and/or user device 110 might store the one or more configuration settings in a remote storage 130 located in the network 125. Based on a determination that the network connection does not exist between the CPE 105 and the network 125, the CPE 105 and/or user device 110 might store the one or more configuration settings in a local storage 115.

The one or more configuration settings associated with at least one of the user or the customer premises 120 may be stored with at least one of a date stamp indicating a date when the one or more configuration settings were stored or a time stamp indicating a time when the one or more configuration settings were stored. In this manner, a user, CPE 105, and/or user device 110 may easily determine the most recent configuration settings that were used on CPE 105. Additionally and/or alternatively, the one or more configuration settings may be stored with a device identifier identifying the CPE 105 associated with the one or more configuration settings. By doing this, a user, CPE 105, and/or user device 110 can determine that the CPE 105 and/or user device 110 is retrieving the configuration settings associated with CPE 105.

After the CPE 105 has been reset, the CPE 105 and/or user device 110 might retrieve one or more configuration settings associated with at least one of a user or a customer premises. The one or more configuration settings associated with at least one of a user or a customer premises 120 are different from one or more factory settings associated with the customer premises device. The one or more configuration settings associated with at least one of a user or a customer premises 120 may be retrieved from local storage device 115, or remote storage device 130, and/or the like.

In some cases, the one or more configuration settings associated with the at least one of the user or the customer premises 120 may be retrieved automatically. In this case, the CPE 105 and/or user device 110 may automatically retrieve the most recent configuration settings associated with at least one of the user or the customer premises 120. Alternatively, the CPE 105 and/or user device 110 may automatically retrieve a last known good data set (i.e., one or more configurations settings associated with at least one of the user or the customer premises 120 or a data set that has previously been deemed to be optimal or desired, or the like).

In some embodiments, in response to receiving the request to reset CPE 105, CPE 105 and/or user device 110 may retrieve the one or more configuration settings and display the one or more configuration settings associated with the at least one of the user or the customer premises 120 to a user. The configurations settings may be displayed to the user in a list. The list might include, without limitation, at least one of one or more most recent configuration setting, one or more prior configuration settings, or one or more factory default settings. In this manner, a user may choose to reset the CPE 105 with one or more most recent configuration settings, one or more prior configuration settings, one or more optimal or desired configuration settings, or one or more factory default settings. In a non-limiting example, if the most recent configuration settings are not optimal or desired, a user may reset CPE 105 to one or more prior configuration settings or one or more factory default settings that are optimal or desired.

In some embodiments, the CPE 105 and/or user device(s) 110 may then set the one or more configuration settings associated with the at least one of the user or the customer premises 120 on the CPE 105 (e.g., CPE 105, and/or the like). In this way, the configuration settings may easily be restored on CPE 105. In some cases, the one or more configuration settings may also be configured on a second CPE 105b which is different from CPE 105a. In this manner, CPE 105a may be easily replaced with CPE 105b.

In a non-limiting example, if the CPE 105a is a first modem and CPE 105b is a second modem, the first modem may be easily replaced by the second modem. The first modem, user device(s) 110, and/or second modem may request that the one or more configuration settings associated with the at least one of the user or the customer premises 120 be set up on the second modem. Once the configuration settings associated with the at least one of the user or the customer premises 120 are set up on the second modem, one or more user devices 110 or CPE 105 may be automatically coupled to the second modem without having to change any of the configuration settings for the one or more user devices 110 or CPE 105. The configuration settings may be set up on the second modem by retrieving the configuration settings associated with the at least one of the user or the customer premises 120 from local storage device 115, or remote storage device 130, and/or the like.

The one or more configuration settings associated with the at least one of the user or the customer premises 120 that are set on the CPE 105 are associated with user, technician, or customer premises configured settings. Restoring or installing the user configured data or customer premises configured data places the CPE 105 into a state where it can perform as previously configured by a user, technician, CPE 105, and/or user device(s) 110. This is different from a factory default setting which would restore the CPE 105 back into its factory condition without any settings or data configured by a user, technician, CPE 105, and/or user device(s) 110.

In some embodiments, in operation, CPE 105 and/or user device 110 might determine whether an outage in a network 125 has occurred. Based on a determination that the outage in the network has occurred, the CPE 105 and/or user device 110 might determine whether the CPE 105 has been reset. This determination may be made when the network outage is over or during the network outage.

During the network outage, the CPE 105 may have received a request to reset the CPE 105. The request to reset the CPE 105 might be received from a user device 110, from a device in the service provider network 135, and/or from a hardware button 140 located on the CPE 105. The request to reset the CPE 105 may be received via a reset signal generated by the user device 110, the service provider device 135, and/or the hardware button 140 located on the CPE 105. The hardware button 140 may be a factory reset button located on the CPE 105. Alternatively, the hardware button 140 may instead be a software button displayed on the CPE 105. The software button may be a factory reset button displayed on the CPE 105.

In response to receiving the request to reset the CPE 105, the CPE 105 and/or the user device 110 may store one or more configuration settings associated with the at least one of a user or a customer premises of the CPE 105.

Based on a determination that the CPE 105 has been reset, the CPE 105 and/or user device 110 might retrieve the one or more configuration settings of the CPE 105. The reset may have caused the CPE 105 to reset back to factory settings. Thus, based on determination that the CPE 105 has been reset back to factory settings, the CPE 105 and/or the user device 110 might retrieve one or more configuration settings associated with at least one of a user or a customer premises that have been set by the user and/or technician.

The CPE 105 and/or the user device 110 might automatically retrieve the most recent set of configuration settings, the last known good set of configuration settings, and/or user configuration settings selected by a user on a list displayed to the user.

The one or more configuration settings may be retrieved from at least one of a local storage 115 or a remote storage device 130 by the CPE 105 and/or the user device 110. These stored configuration settings associated with the user and/or customer premises are different from factory settings designed to place a customer premises device back into its factory state.

The CPE 105 and/or the user device 110 might then configure the CPE 105 with the one or more configuration settings associated with the at least one of the user or the customer premises.

FIG. 2 illustrates a system 200 for implementing configuration data and settings on customer premises equipment 205, in accordance with various embodiments.

System 200 might include one or more CPE 205. CPE 205 might additionally include local storage 210. In some cases, local storage 210 might be integrated within CPE 205. In other cases, the local storage 210 might be external to CPE 205. CPE 205 and/or local storage 210 might additionally be contained within customer premises 215.

In various embodiments, the configuration data and/or settings associated with the at least one of the user or the customer premises 215 of CPE 205 might be stored locally in local storage device 210, using a suitable type of non-volatile storage technology. Examples of such storage technologies might include, but are not limited to, Flash, Electrically Erasable Programmable Random-Access Memory (EEPROM), hard disk, or any other suitable storage technology, and/or the like.

The configuration data and/or settings associated with the at least one of the user or the customer premises 215 of CPE 205 might be stored by CPE 205 in response to receiving a request to reset the CPE 205. The request to reset the CPE 205 might be received via a hardware button 230. Hardware button 230 may be a reset button or a factory default reset button. Additionally and/or alternatively, the configuration data and/or settings associated with the at least one of the user or the customer premises 215 of CPE 205 might be stored by CPE 205 in response to determining that an outage in a network 220 has occurred.

CPE 205 may also store configuration settings or data when CPE 205 and/or customer support system/service provider device 225 detects a change in CPE 205's configuration settings or data. For example, each time a user or technician changes the configuration settings or data, CPE 205 may store the changed configuration settings or data in local storage device 210. Additionally and/or alternatively, the one or more configuration settings associated with the at least one of the user or the customer premises may be periodically (e.g., hourly, daily, weekly, monthly, etc.) stored on local storage device 210.

The operator's customer support system 225 may have visibility into the CPE 205 as well as local storage device 210 via network(s) 220. In other words, customer support system 225 may be able to access CPE 205 and/or local storage device 210 via network(s) 220. Thus, when a user is attempting to reconfigure CPE 205, after CPE 205 has been reset, customer support system 225 may assist in reconfiguring CPE 205 or in initiating CPE 205 configuration by accessing local storage device 210 and setting up the stored configuration settings on CPE 205.

In various embodiments, when customer support system 225 and/or CPE 205 detects at least one of a request to reset the customer premises device or whether an outage in a network has occurred, the customer support system 225 and/or CPE 205 may prompt the user about restoring a known good data set (i.e., a user configured data set or a data set that has previously been deemed to be optimal or desired, or the like) on CPE 205. A known good data set (i.e., a user configured data set or a data set that has previously been deemed to be optimal or desired, or the like) may be retrieved from the local storage device 210 by customer support system 225 and/or CPE 205 and set up on CPE 205.

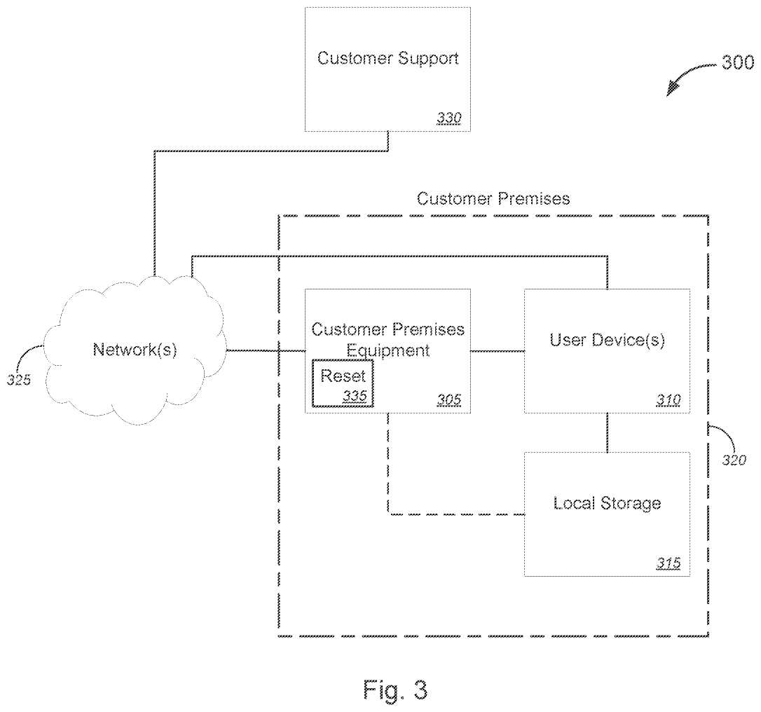

FIG. 3 illustrates yet another system 300 for implementing configuration data and settings on customer premises equipment 305, in accordance with various embodiments.

System 300 might comprise one or more CPE 305. System 300 might additionally comprise user device(s) 310 with local storage 315. In some cases, local storage 315 might be integrated within user device(s) 310. In other cases, local storage 315 might be integrated within CPE 305. In yet other cases, the local storage 315 might be external to user device(s) 310. CPE 305, user device(s) 310, and/or local storage 315 might additionally be contained within customer premises 320.

In various embodiments, the configuration data and/or settings associated with the at least one of the user or the customer premises 320 of CPE 305 might be stored locally in local storage 315 associated with the user device(s) 310, using a suitable type of non-volatile storage technology. Examples of such storage technologies might include, but are not limited to, Flash, Electrically Erasable Programmable Random-Access Memory (EEPROM), hard disk, or any other suitable storage technology, and/or the like.

The configuration data and/or settings associated with the at least one of the user or the customer premises 320 of CPE 305 might be stored by CPE 305, user device(s) 310, and/or customer support system/service provider device 330 in response to receiving a request to reset the CPE 305. The request to reset the CPE 305 might be received via a hardware button 335. Hardware button 335 may be a reset button or a factory default reset button. Additionally and/or alternatively, the configuration data and/or settings associated with the at least one of the user or the customer premises 320 of CPE 305 might be stored by CPE 305, user device(s) 310, and/or customer support system 330 in response to determining that an outage in a network 325 has occurred.

CPE 305, user device(s) 310, and/or customer support system 330, may store configuration settings or data when CPE 305 and/or user device(s) 310 detects a change in CPE 205's configuration settings or data on local storage device(s) 315. For example, each time a user or technician or CPE 305 changes the configuration settings or data on CPE 305, CPE 305 and/or user device(s) 310 may store the changed configuration settings or data in local storage device(s) 315. Additionally and/or alternatively, the one or more configuration settings associated with the at least one of the user or the customer premises may be periodically (e.g., hourly, daily, weekly, monthly, etc.) stored on local storage device(s) 315. A user may also request that the configuration settings be stored on a local storage device(s) associated with the CPE 305 or a user device(s) 310. A user may select a particular user device(s) 310 and/or local storage device(s) 315 to store the one or more configuration settings.

The operator's customer support system 330 may have visibility into the CPE 305 as well as user device(s) 310 and local storage device(s) 315 via network(s) 325. A user may opt into the customer support system 330 having visibility. When the user opts into the customer support system 330 having visibility, customer support system 330 may be able to access CPE 305, user device(s) 310, and/or local storage device(s) 315 via network(s) 325. Thus, when a user is attempting to reconfigure CPE 305, after CPE 305 has been reset, customer support system 330 may assist in reconfiguring CPE 305 or in initiating CPE 305 configuration by accessing local storage device(s) 315 of user device(s) 310 and setting up the stored configuration settings on CPE 305.

In various embodiments, when customer support system 330, CPE 305, and/or user device(s) 310 detects at least one of a request to reset CPE or an outage in network 325, customer support system 330, CPE 305, and/or user device(s) 310 may prompt the user about restoring/setting a known good data set (i.e., a user configured data set or a data set that has previously been deemed to be optimal or desired, or the like) on CPE 305. Additionally and/or alternatively, when customer support system 330, CPE 305, and/or user device(s) 310 detects at least one of a request to reset CPE or an outage in network 325, customer support system 330, CPE 305, and/or user device(s) 310 may automatically restore or set up a known good data set (i.e., a user configured data set or a data set that has previously been deemed to be optimal or desired, or the like) on CPE 305. For example, customer support system 330, CPE 305, and/or user device(s) 310 may automatically restore one or more most recent configuration settings on CPE 305 in response to a detection of at least one of a request to reset CPE or an outage in network 325. A known good data set (i.e., a user configured data set or a data set that has previously been deemed to be optimal or desired, or the like) may be retrieved from the local storage device 315 by customer support system 330, user device 310, and/or CPE 305 and set up on CPE 305.

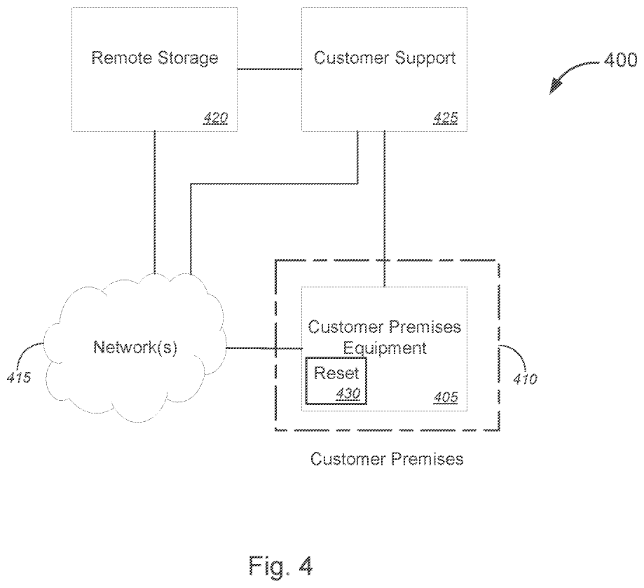

FIG. 4 illustrates a system 400 for implementing configuration data and settings on customer premises equipment 405, in accordance with various embodiments.

System 400 might comprise one or more CPE 405. CPE 405 might be contained within customer premises 410.

In various embodiments, the configuration data and/or settings associated with the at least one of the user or the customer premises 410 of CPE 405 might be stored remotely in remote storage device 420, using a suitable type of non-volatile storage technology. Examples of such storage technologies might include, but are not limited to, Flash, Electrically Erasable Programmable Random-Access Memory (EEPROM), hard disk, or any other suitable storage technology, and/or the like. Remote storage device 420 may be located in a service provider network, a content provider network, or a customer support system/service provider device 425, and/or the like. CPE 405 might be communicatively coupled to remote storage device 420 via one or more network(s) 415.

The configuration data and/or settings associated with the at least one of the user or the customer premises 410 of CPE 405 might be stored by CPE 405 and/or customer support 425 in response to receiving a request to reset the CPE 405. The request to reset the CPE 405 might be received via a hardware button 430. Hardware button 430 may be a reset button or a factory default reset button. Additionally and/or alternatively, the configuration data and/or settings associated with the at least one of the user or the customer premises 410 of CPE 405 might be stored by CPE 405 in response to determining that an outage in a network 415 has occurred.

CPE 405 and/or customer support system 425 may also store configuration settings or data when CPE 405 and/or customer support system 425 detects a change in CPE 405's configuration settings or data. For example, each time a user or technician changes the configuration settings or data, CPE 405 and/or customer support 425 may store the changed configuration settings or data in a remote storage device 420. Additionally and/or alternatively, the one or more configuration settings associated with the at least one of the user or the customer premises may be periodically (e.g., hourly, daily, weekly, monthly, etc.) stored on remote storage device 420.

The operator's customer support system 425 may have visibility into the CPE 405 as well as remote storage device 420 via network(s) 415. Additionally and/or alternatively, remote storage device 420 may be located in customer support system 425. Thus, when a user is attempting to reconfigure CPE 405, after CPE 405 has been reset, customer support system 425 may assist in reconfiguring CPE 405 or in initiating CPE 405 configuration by accessing remote storage device 420 and setting up the stored configuration settings on CPE 405.

In various embodiments, when customer support system 425 and/or CPE 405, detects at least one of a request to reset CPE 405 or an outage in network 415, customer support system 425 and/or CPE 405 may prompt the user about restoring a known good data set (i.e., a user configured data set or a data set that has previously been deemed to be optimal or desired, or the like) on CPE 405. Additionally and/or alternatively, when customer support system 425 and/or CPE 405 detects at least one of a request to reset CPE or an outage in network 415, customer support system 425 and/or CPE 405 may automatically restore or set up a known good data set (i.e., a user configured data set or a data set that has previously been deemed to be optimal or desired, or the like) on CPE 405. A known good data set (i.e., a user configured data set or a data set that has previously been deemed to be optimal or desired, or the like) may be retrieved from the remote storage device 420 by customer support system 425 and/or CPE 405 and set up on CPE 405.

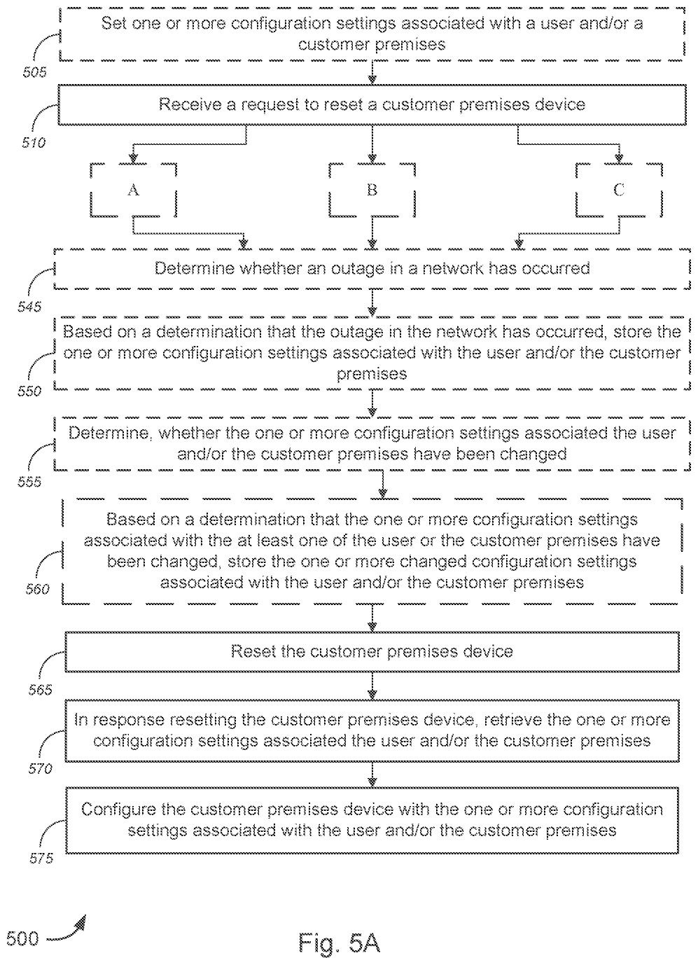

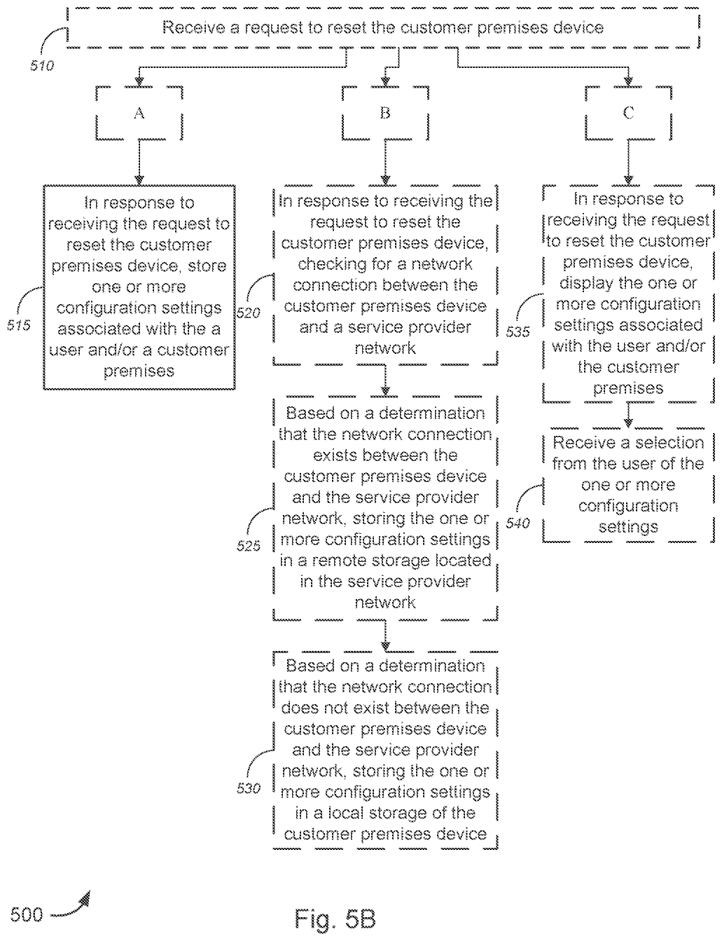

FIGS. 5A and 5B (collectively, “FIG. 5”) are flow diagrams illustrating a method 500 for implementing configuration data and settings on customer premises equipment, in accordance with various embodiments.

While the techniques and procedures are depicted and/or described in a certain order for purposes of illustration, it should be appreciated that certain procedures may be reordered and/or omitted within the scope of various embodiments. Moreover, while the method 500 illustrated by FIG. 5 can be implemented by or with (and, in some cases, are described below with respect to) the systems 100, 200, 300, and 400 of FIGS. 1, 2, 3, and 4, respectively (or components thereof), such methods may also be implemented using any suitable hardware (or software) implementation. Similarly, while each of the systems 100, 200, 300, and 400 of FIGS. 1, 2, 3, and 4, respectively (or components thereof), can operate according to the method 500 illustrated by FIG. 5 (e.g., by executing instructions embodied on a computer readable medium), the systems 100, 200, 300, and 400 of FIGS. 1, 2, 3, and 4, respectively, can each also operate according to other modes of operation and/or perform other suitable procedures.

In the non-limiting embodiment of FIG. 5, method 500, at optional block 505, might comprise setting one or more configuration settings associated with at least one of a user or a customer premises on a customer premises device. The customer premises device might include, but is not limited to, one of a modem, an optical network terminal, a set-top box (“STB”), a gateway, a media player, a gaming console, a camera, a sensor, a thermostat, a desktop computer, or a laptop computer, and/or the like. The modem might include at least one of a digital subscriber line modem, a G.fast modem, or a cable modem, and/or the like. The set-top box might include an internet protocol television set-top box, or an over-the-top set-top box, and/or the like. The gateway might include at least one of a residential gateway, business gateway, a pay-per-view gateway, or a security gateway, and/or the like.

The one or more configuration settings might be set manually by a user, manually by a technician installing or servicing the first customer premises device, automatically by the first customer premises device, or automatically by a user device (e.g., one of a laptop computer, a tablet computer, a desktop computer, a smart phone, a mobile phone, a personal digital assistant, a remote control device, a gaming console, a set-top box, a media player, a portable gaming device, a camera, a sensor, or a thermostat, and/or the like), and/or the like.

The one or more configuration settings are different from factory settings of a customer premises device and unique to the at least one of the user or the customer premises. The one or more configuration settings or data might include, but are not limited to, one or more local area network settings, one or more wide area network settings, one or more service set identifiers, one or more login credentials (e.g., login name, password, email address, etc.), one or more Internet protocol (“IP”) addresses, one or more domain names, one or more security settings, one or more remote management settings, one or more encryption types, one or more frequency settings (e.g., bandwidth settings, frequency agility settings, one or more blocked addresses (e.g., website addresses, media access control addresses, etc.), one or more permitted addresses (e.g., website addresses, media access control addresses, etc.), one or more calibration settings (e.g., calibration settings of television, calibration settings of modem, etc.), one or more display settings (e.g., display settings of television, etc.), or one or more temperature settings, and/or the like.

Method 500 might further comprise, at block 510, receiving, with a customer premises device, a request to reset the customer premises device. The request to reset the customer premises device might be received from a user device, from a device in the service provider network, and/or from a hardware button located on the customer premises device. The request to reset the customer premises device may be received via a reset signal generated by the user device, the service provider device, and/or the hardware button located on the customer premises device. The hardware button may be a factory reset button located on the customer premises device. Alternatively, the hardware button may be a software button displayed on the customer premises device. The software button may be a factory reset button displayed on the customer premises device.

In response to receiving the request to reset the customer premises device, the method 500 may proceed to block A, block B, and/or block C, which are shown in FIG. 5B. At block A, method 500 might continue at block 515 by storing, with the customer premises device, a user device, and/or a device located in a service provider network, one or more configuration settings associated with the at least one of a user or a customer premises of the customer premises device. The one or more configuration settings may be stored in response to receiving the request to reset the customer premises device.

The customer premises device may store the configuration settings locally in a local storage communicatively coupled to the customer premises device or in a remote storage communicatively coupled to the customer premises device. The remote storage might be located in a service provider or content provider network. Additionally and/or alternatively, the remote storage may be located in a user device located at the customer premises.

The one or more configuration settings of the customer premises device may be stored with at least one of a date stamp indicating a date when the one or more configuration settings were stored or a time stamp indicating a time when the one or more configuration settings were stored. Additionally and/or alternatively, the one or more configuration settings of the customer premises device may be stored with a device identifier identifying the customer premises device associated with the one or more configuration settings.

At optional block B, the method 500 might continue, at optional block 520, by checking, with the customer premises device, for a network connection between the customer premises device and a service provider network, in response to receiving the request to reset the customer premises device. Based on a determination that the network connection exists between the customer premises device and the service provider network, the method 500, at optional block 525, might store the one or more configuration settings in a remote storage located in the service provider network. Based on a determination that the network connection does not exist between the customer premises device and the service provider network, the method 500, at optional block 530, might store the one or more configuration settings in a local storage of the customer premises device.

In some embodiments, at optional block C, the method 500 might continue, at optional block 535, by displaying, with the customer premises device, a user device, and/or a service provider device, the one or more configuration settings associated with the at least one of the user or the customer premises. The one or more configuration settings may be displayed in response to receiving the request to reset the customer premises device. The method 500 may continue at block 540 by receiving, with the customer premises device, the user device, and/or the service provider device, a selection from the user of the one or more configuration settings. The one or more configuration settings may be displayed in a list to the user and the list may include, without limitation, at least one of one or more most recent configuration setting, one or more prior configuration settings, and/or one or more factory default settings.

At optional block 545, method 500 might include determining, with the customer premises device, whether an outage in a network has occurred. Based on a determination that the outage in the network has occurred, the method 500, at optional block 550 might continue by storing, with the customer premises device, the one or more configuration settings associated with the at least one of the user or the customer premises.

At optional block 555, method 500 might comprise determining, with the customer premises device, whether the one or more configuration settings associated with the at least one of the user or the customer premises have been changed. A user and/or technician may manually change the one or more configuration settings. Alternatively, the customer premises device may change the configuration settings automatically. At optional block 560, method 500 might additionally comprise storing, with the customer premises device, the one or more changed configuration settings associated with the at least one of the user or the customer premises, based on a determination that the one or more configuration settings associated with the at least one of the user or the customer premises have been changed.

Additionally and/or alternatively, the one or more configuration settings associated with the at least one of the user or the customer premises may be periodically (e.g., hourly, daily, weekly, monthly, etc.) stored on a local storage device and/or remote storage device.

The method 500, at block 565, might then reset, with the customer premises device, service provider device, and/or user device, the customer premises device. In response to resetting the customer premises device, method 500, at block 570 might continue by retrieving, with the customer premises device, service provider device, and/or user device, the one or more configuration settings associated with at least one of the user or the customer premises.

The customer premises device, service provider device, and/or user device might automatically retrieve the most recent set of configuration settings or the last known good set of configuration settings. Alternatively, the customer premises device, service provider device, and/or user device might retrieve the user configuration settings selected by a user on a list displayed to the user.

In some embodiments, the customer premises device, service provider device, and/or user device might retrieve the one or more configuration settings based on at least one of a date stamp indicating a date when the one or more configuration settings were stored or a time stamp indicating a time when the one or more configuration settings were stored. Additionally and/or alternatively, the customer premises device, service provider device, and/or user device might retrieve the one or more configuration settings the device identifier identifying the customer premises device associated with the one or more configuration settings.

The one or more configuration settings may be retrieved from at least one of a local storage device or a remote storage device by the customer premises device, service provider device, and/or the user device, and/or the like. These stored configuration settings associated with the user and/or customer premises are different from factory settings designed to place a customer premises device back into its factory state.

The method 500, at block 575, might additionally include configuring, with the at least one of the customer premises device, the service provider device, the user device, the customer premises device with the one or more configuration settings associated with the at least one of the user or the customer premises.

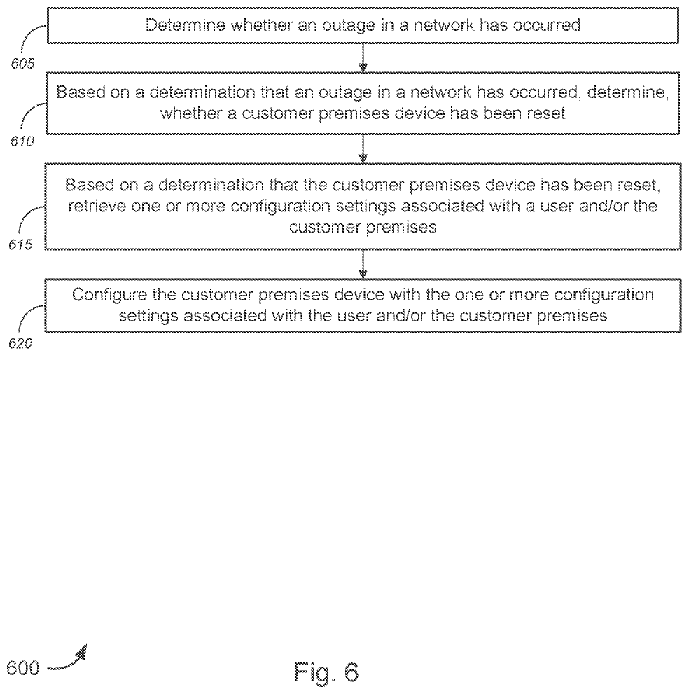

FIG. 6 is a flow diagram illustrating a method 600 for implementing configuration data and settings on customer premises equipment, in accordance with various embodiments.

While the techniques and procedures are depicted and/or described in a certain order for purposes of illustration, it should be appreciated that certain procedures may be reordered and/or omitted within the scope of various embodiments. Moreover, while the method 600 illustrated by FIG. 6 can be implemented by or with (and, in some cases, are described below with respect to) the systems 100, 200, 300, and 400 of FIGS. 1, 2, 3, and 4, respectively (or components thereof) and method 500 of FIG. 5, such methods may also be implemented using any suitable hardware (or software) implementation. Similarly, while each of the systems 100, 200, 300, and 400 of FIGS. 1, 2, 3, and 4, respectively (or components thereof) and method 500 of FIG. 5, can operate according to the method 600 illustrated by FIG. 6 (e.g., by executing instructions embodied on a computer readable medium), the systems 100, 200, 300, and 400 of FIGS. 1, 2, 3, and 4, respectively and method 500 of FIG. 5, can each also operate according to other modes of operation and/or perform other suitable procedures.

In the non-limiting embodiment of FIG. 6, method 600, at block 605, might comprise determining, with a customer premises device, a service provider device, and/or a user device, whether an outage in a network has occurred. The customer premises device might include, but is not limited to, one of a modem, an optical network terminal, a set-top box (“STB”), a gateway, a media player, a gaming console, a camera, a sensor, a thermostat, a desktop computer, or a laptop computer, and/or the like. The modem might include at least one of a digital subscriber line modem, a G.fast modem, or a cable modem, and/or the like. The set-top box might include an internet protocol television set-top box, or an over-the-top set-top box, and/or the like. The gateway might include at least one of a residential gateway, business gateway, a pay-per-view gateway, or a security gateway, and/or the like. The service provider device might comprise at least one of a laptop, a computer, a server computer, and/or the like within the service provider network. In some embodiments, the user device might include, without limitation, one of a laptop computer, a tablet computer, a desktop computer, a smart phone, a mobile phone, a personal digital assistant, a remote control device, a gaming console, a set-top box, a media player, a portable gaming device, a camera, a sensor, or a thermostat, and/or the like.

Based on a determination that the outage in the network has occurred, the method 600, at block 610, might include determining, with the customer premises device, the service provider device, and/or the user device, whether the customer premises device has been reset. This determination may be made when the network outage is over or during the network outage.

During the network outage, the customer premises device may have received a request to reset the customer premises device. The request to reset the customer premises device might be received from a user device, from a device in the service provider network, and/or from a hardware button located on the customer premises device. The request to reset the customer premises device may be received via a reset signal generated by the user device, the service provider device, and/or the hardware button located on the customer premises device. The hardware button may be a factory reset button located on the customer premises device. Alternatively, the hardware button may be a software button displayed on the customer premises device. The software button may be a factory reset button displayed on the customer premises device.

In response to receiving the request to reset the customer premises device, the customer premises device, the user device, and/or the device located in a service provider network, may store one or more configuration settings associated with the at least one of a user or a customer premises of the customer premises device.

Based on a determination that the customer premises device has been reset, the method 600, at block 615, may continue by retrieving, with the customer premises device, the service provider device, and/or the user device, one or more configuration settings of the customer premises device and associated with at least one of a user or a customer premises. The reset may have caused the customer premises device to reset back to factory settings. Thus, based on determination that the customer premises device has been reset back to factory settings, the customer premises device, the service provider device, and/or the user device might retrieve one or more configuration settings associated with at least one of a user or a customer premises that have been set by the user and/or technician.

The customer premises device, service provider device, and/or user device might automatically retrieve the most recent set of configuration settings, the last known good set of configuration settings, and/or user configuration settings selected by a user on a list displayed to the user.

The one or more configuration settings may be retrieved from at least one of a local storage device or a remote storage device by the customer premises device, service provider device, and/or the user device, and/or the like. These stored configuration settings associated with the user and/or customer premises are different from factory settings designed to place a customer premises device back into its factory state.

The method 600, at block 620, might additionally include configuring, with the at least one of the customer premises device, the service provider device, and/or the user device, the customer premises device with the one or more configuration settings associated with the at least one of the user or the customer premises.

### Exemplary System and Hardware Implementation

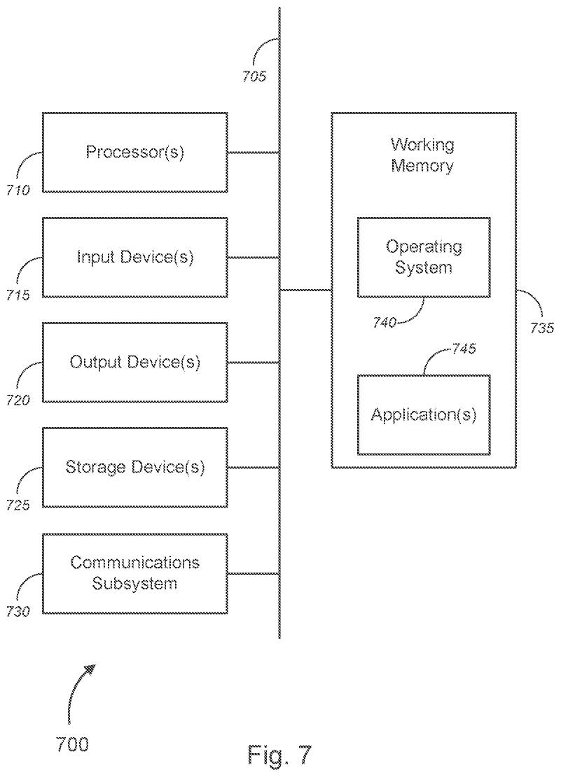

FIG. 7 is a block diagram illustrating an exemplary computer or system hardware architecture, in accordance with various embodiments. FIG. 7 provides a schematic illustration of one embodiment of a computer system 700 of the service provider system hardware that can perform the methods provided by various other embodiments, as described herein, and/or can perform the functions of computer or hardware system (i.e., customer premises equipment 105, 205, 305, and 405, user devices 110 and 310, customer support systems 135, 225, 330, and 425, local storage devices 115, 210, and 315, and remote storage devices 130 and 420, etc.), as described above. It should be noted that FIG. 7 is meant only to provide a generalized illustration of various components, of which one or more (or none) of each may be utilized as appropriate. FIG. 7, therefore, broadly illustrates how individual system elements may be implemented in a relatively separated or relatively more integrated manner.

The computer or hardware system 700—which might represent an embodiment of the computer or hardware system (i.e., customer premises equipment 105, 205, 305, and 405, user devices 110 and 310, customer support systems 135, 225, 330, and 425, local storage devices 115, 210, and 315, and remote storage devices 130 and 420, etc.), described above with respect to FIGS. 1-6—is shown comprising hardware elements that can be electrically coupled via a bus 705 (or may otherwise be in communication, as appropriate). The hardware elements may include one or more processors 710, including, without limitation, one or more general-purpose processors and/or one or more special-purpose processors (such as microprocessors, digital signal processing chips, graphics acceleration processors, and/or the like); one or more input devices 715, which can include, without limitation, a mouse, a keyboard and/or the like; and one or more output devices 720, which can include, without limitation, a display device, a printer, and/or the like.

The computer or hardware system 700 may further include (and/or be in communication with) one or more storage devices 725, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable and/or the like. Such storage devices may be configured to implement any appropriate data stores, including, without limitation, various file systems, database structures, and/or the like.

The computer or hardware system 700 might also include a communications subsystem 730, which can include, without limitation, a modem, a network card (wireless or wired), an infra-red communication device, a wireless communication device and/or chipset (such as a Bluetooth™ device, an 802.11 device, a WiFi device, a WiMax device, a WWAN device, cellular communication facilities, etc.), and/or the like. In some aspects, the communications subsystem 730 might also comprise a wireless video link system, which might utilize a wireless video link protocol comprising at least one of WirelessHD protocol, Wireless Home Digital Interface (“WHDI”) protocol, or Wireless Gigabit Alliance (“WiGig”) protocol, and/or the like. The communications subsystem 730 may permit data to be exchanged with a network (such as the network described below, to name one example), with other computer or hardware systems, and/or with any other devices described herein. In many embodiments, the computer or hardware system 700 will further comprise a working memory 735, which can include a RAM or ROM device, as described above.

The computer or hardware system 700 also may comprise software elements, shown as being currently located within the working memory 735, including an operating system 740, device drivers, executable libraries, and/or other code, such as one or more application programs 745, which may comprise computer programs provided by various embodiments (including, without limitation, hypervisors, VMs, and the like), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 725 described above. In some cases, the storage medium might be incorporated within a computer system, such as the system 700. In other embodiments, the storage medium might be separate from a computer system (i.e., a removable medium, such as a compact disc, etc.), and/or provided in an installation package, such that the storage medium can be used to program, configure and/or adapt a general purpose computer with the instructions/code stored thereon. These instructions might take the form of executable code, which is executable by the computer or hardware system 700 and/or might take the form of source and/or installable code, which, upon compilation and/or installation on the computer or hardware system 700 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 700) to perform methods in accordance with various embodiments of the invention. According to a set of embodiments, some or all of the procedures of such methods are performed by the computer or hardware system 700 in response to processor 710 executing one or more sequences of one or more instructions (which might be incorporated into the operating system 740 and/or other code, such as an application program 745) contained in the working memory 735. Such instructions may be read into the working memory 735 from another computer readable medium, such as one or more of the storage device(s) 725. Merely by way of example, execution of the sequences of instructions contained in the working memory 735 might cause the processor(s) 710 to perform one or more procedures of the methods described herein.

The terms “machine readable medium” and “computer readable medium,” as used herein, refer to any medium that participates in providing data that causes a machine to operate in a specific fashion. In an embodiment implemented using the computer or hardware system 700, various computer readable media might be involved in providing instructions/code to processor(s) 710 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 725. Volatile media includes, without limitation, dynamic memory, such as the working memory 735. In some alternative embodiments, a computer readable medium may take the form of transmission media, which includes, without limitation, coaxial cables, copper wire and fiber optics, including the wires that comprise the bus 705, as well as the various components of the communication subsystem 730 (and/or the media by which the communications subsystem 730 provides communication with other devices). In an alternative set of embodiments, transmission media can also take the form of waves (including without limitation radio, acoustic and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 710 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 700. These signals, which might be in the form of electromagnetic signals, acoustic signals, optical signals, and/or the like, are all examples of carrier waves on which instructions can be encoded, in accordance with various embodiments of the invention.

The communications subsystem 730 (and/or components thereof) generally will receive the signals, and the bus 705 then might carry the signals (and/or the data, instructions, etc. carried by the signals) to the working memory 735, from which the processor(s) 705 retrieves and executes the instructions. The instructions received by the working memory 735 may optionally be stored on a storage device 725 either before or after execution by the processor(s) 710.

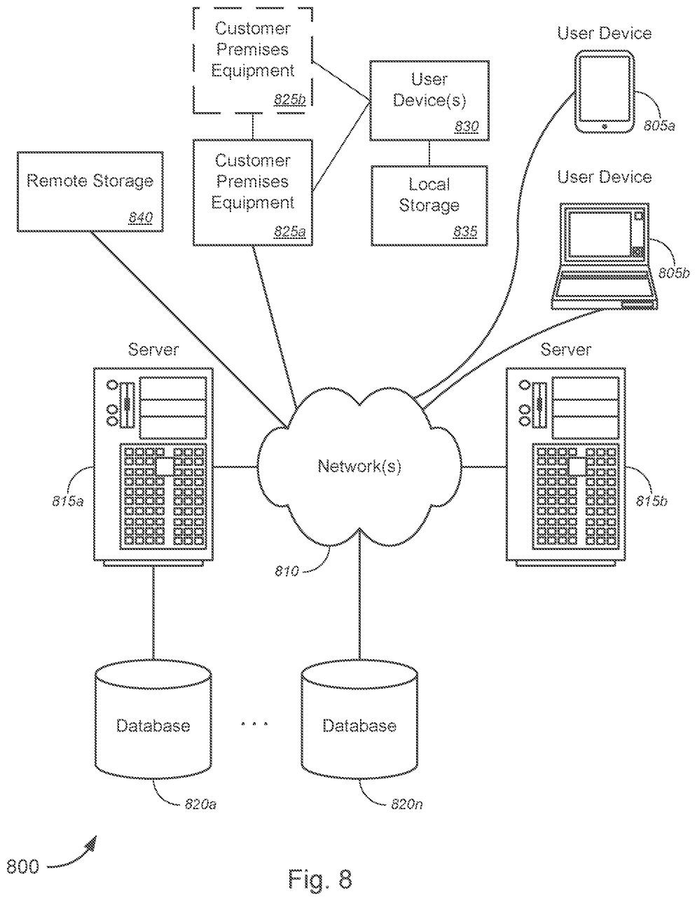

As noted above, a set of embodiments comprises methods and systems for implementing configuration data and settings on customer premises equipment (“CPE”), and, more particularly, to methods, systems, and apparatuses for implementing storage, retrieval, and transfer of configuration data and settings in response to receiving a request to reset the CPE. FIG. 8 illustrates a schematic diagram of a system 800 that can be used in accordance with one set of embodiments. The system 800 can include one or more user computers, user devices, or customer devices 805. A user computer, user device, or customer device 805 can be a general purpose personal computer (including, merely by way of example, desktop computers, tablet computers, laptop computers, handheld computers, and the like, running any appropriate operating system, several of which are available from vendors such as Apple, Microsoft Corp., and the like), cloud computing devices, a server(s), and/or a workstation computer(s) running any of a variety of commercially-available UNIX™ or UNIX-like operating systems. A user computer, user device, or customer device 805 can also have any of a variety of applications, including one or more applications configured to perform methods provided by various embodiments (as described above, for example), as well as one or more office applications, database client and/or server applications, and/or web browser applications. Alternatively, a user computer, user device, or customer device 805 can be any other electronic device, such as a thin-client computer, Internet-enabled mobile telephone, and/or personal digital assistant, capable of communicating via a network (e.g., the network(s) 810 described below) and/or of displaying and navigating web pages or other types of electronic documents. Although the exemplary system 800 is shown with two user computers, user devices, or customer devices 805, any number of user computers, user devices, or customer devices can be supported.

Certain embodiments operate in a networked environment, which can include a network(s) 810. The network(s) 810 can be any type of network familiar to those skilled in the art that can support data communications using any of a variety of commercially-available (and/or free or proprietary) protocols, including, without limitation, TCP/IP, SNA™, IPX™, AppleTalk™, and the like. Merely by way of example, the network(s) 810 (similar to network(s) 125 of FIG. 1, network(s) 220 of FIG. 2, network(s) 325 of FIG. 3, and network(s) 415 of FIG. 4, or the like) can each include a local area network (“LAN”), including, without limitation, a fiber network, an Ethernet network, a Token-Ring™ network and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the network might include an access network of the service provider (e.g., an Internet service provider (“ISP”)). In another embodiment, the network might include a core network of the service provider, and/or the Internet.

Embodiments can also include one or more server computers 815. Each of the server computers 815 may be configured with an operating system, including, without limitation, any of those discussed above, as well as any commercially (or freely) available server operating systems. Each of the servers 815 may also be running one or more applications, which can be configured to provide services to one or more clients 805 and/or other servers 815.

Merely by way of example, one of the servers 815 might be a data server, a web server, a cloud computing device(s), or the like, as described above. The data server might include (or be in communication with) a web server, which can be used, merely by way of example, to process requests for web pages or other electronic documents from user computers 805. The web server can also run a variety of server applications, including HTTP servers, FTP servers, CGI servers, database servers, Java servers, and the like. In some embodiments of the invention, the web server may be configured to serve web pages that can be operated within a web browser on one or more of the user computers 805 to perform methods of the invention.

The server computers 815, in some embodiments, might include one or more application servers, which can be configured with one or more applications accessible by a client running on one or more of the client computers 805 and/or other servers 815. Merely by way of example, the server(s) 815 can be one or more general purpose computers capable of executing programs or scripts in response to the user computers 805 and/or other servers 815, including, without limitation, web applications (which might, in some cases, be configured to perform methods provided by various embodiments). Merely by way of example, a web application can be implemented as one or more scripts or programs written in any suitable programming language, such as Java™, C, C#™ or C++, and/or any scripting language, such as Perl, Python, or TCL, as well as combinations of any programming and/or scripting languages. The application server(s) can also include database servers, including, without limitation, those commercially available from Oracle™, Microsoft™, Sybase™, IBM™, and the like, which can process requests from clients (including, depending on the configuration, dedicated database clients, API clients, web browsers, etc.) running on a user computer, user device, or customer device 805 and/or another server 815. In some embodiments, an application server can perform one or more of the processes for implementing configuration data and settings on customer premises equipment (“CPE”), and, more particularly, to methods, systems, and apparatuses for implementing configuration data and settings on customer premises equipment (“CPE”), and, more particularly, to methods, systems, and apparatuses for implementing storage, retrieval, and transfer of configuration data and settings in response to receiving a request to reset the CPE, as described in detail above. Data provided by an application server may be formatted as one or more web pages (comprising HTML, JavaScript, etc., for example) and/or may be forwarded to a user computer 805 via a web server (as described above, for example). Similarly, a web server might receive web page requests and/or input data from a user computer 805 and/or forward the web page requests and/or input data to an application server. In some cases, a web server may be integrated with an application server.

In accordance with further embodiments, one or more servers 815 can function as a file server and/or can include one or more of the files (e.g., application code, data files, etc.) necessary to implement various disclosed methods, incorporated by an application running on a user computer 805 and/or another server 815. Alternatively, as those skilled in the art will appreciate, a file server can include all necessary files, allowing such an application to be invoked remotely by a user computer, user device, or customer device 805 and/or server 815.

It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 820a-820n (collectively, “databases 820”). The location of each of the databases 820 is discretionary: merely by way of example, a database 820a might reside on a storage medium local to (and/or resident in) a server 815a (and/or a user computer, user device, or customer device 805). Alternatively, a database 820n can be remote from any or all of the computers 805, 815, so long as it can be in communication (e.g., via the network 810) with one or more of these. In a particular set of embodiments, a database 820 can reside in a storage-area network (“SAN”) familiar to those skilled in the art. (Likewise, any necessary files for performing the functions attributed to the computers 805, 815 can be stored locally on the respective computer and/or remotely, as appropriate.) In one set of embodiments, the database 820 can be a relational database, such as an Oracle database, that is adapted to store, update, and retrieve data in response to SQL-formatted commands. The database might be controlled and/or maintained by a database server, as described above, for example.

According to some embodiments, system 800 might further comprise customer premises equipment (“CPE”) 825a and 825b (similar to customer premises equipment 105, 205, 305, and 405 of FIGS. 1-4, etc.), one or more storage devices (e.g., local storage device 835, remote storage device 840, and/or the like (similar to local storage devices 115, 210, and 315, and/or remote storage device 130 and 420 of FIGS. 1-4), and/or the like.

In operation, the CPE 825 or user device(s) 830 might set one or more configuration settings associated with at least one of a user or a customer premises on CPE 825. Next, the CPE 825 or user device(s) 830 might receive a request to reset the customer premises device. In response to receiving the request to reset the customer premises device 825, the CPE 825 or user device(s) 830 might one or more configuration settings associated with the at least one of a user or a customer premises of the customer premises device. The one or more configuration settings may then be stored in local storage device 835 and/or remote storage device 840. The CPE 825 may then be reset. In response to resetting the customer premises device 825, the customer premises device 825 or the user device 830 might retrieve the one or more configuration settings associated with at least one of the user or the customer premises. The one or more configuration settings associated with at least one of a user or a customer premises are different from one or more factory settings associated with the customer premises device. The customer premises device 825 or the user device 830 might then configure the customer premises device 825 with the one or more configuration settings associated with the at least one of the user or the customer premises.

Restoring or installing the user configured data or settings puts CPE 825 into a state where it can perform as previously configured by a user or technician. This is different from a factory default setting which would restore the CPE 825 back into its factory condition without any settings or data configured by a user. Thus, configuration settings configured by a user or technician may easily be restored or an old CPE 825a may be easily swapped out to be replaced by a new CPE 825a, without having to manually reprogram any user devices 830 and/or other CPE 825.

These and other functions of the system 800 (and its components) are described in greater detail above with respect to FIGS. 1-7.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method, comprising:
receiving, with a customer premises device, a request to reset the customer premises device;
in response to receiving the request to reset the customer premises device, storing, with the customer premises device, one or more configuration settings associated with the at least one of a user or a customer premises of the customer premises device;
resetting, with the customer premises device, the customer premises device;
in response to resetting the customer premises device, retrieving, with the customer premises device, the one or more configuration settings associated with at least one of the user or the customer premises, wherein the one or more configuration settings associated with at least one of the user or the customer premises are different from one or more factory settings associated with the customer premises device; and
configuring, with the customer premises device, the customer premises device with the one or more configuration settings associated with the at least one of the user or the customer premises.

2. The method of claim 1, wherein the customer premises device comprises at least one of a modem, an optical network terminal, a set-top box, a gateway device, a media player, a gaming console, a camera, a sensor, a thermostat, a desktop computer, or a laptop computer.

3. The method of claim 1, wherein the one or more configuration settings comprise at least one of one or more local area network settings, one or more wide area network settings, one or more service set identifiers, one or more login credentials, one or more Internet protocol (“IP”) addresses, one or more domain names, one or more security settings, one or more remote management settings, one or more encryption types, one or more frequency settings, one or more blocked addresses, one or more permitted addresses, one or more calibration settings, or one or more display settings.

4. The method of claim 1, further comprising:
setting, on the customer premises device and by the user, the one or more configuration settings associated with the at least one of the user or the customer premises.

5. The method of claim 1, wherein the one or more configuration settings associated with the at least one of the user or the customer premises are stored on and retrieved from at least one of a local storage device associated with the customer premises device, a remote storage device associated with a user device located at the customer premises, or a remote storage device located in a service provider network.

6. The method of claim 1, wherein the one or more configuration settings are stored with at least one of a date stamp indicating a date when the one or more configuration settings were stored or a time stamp indicating a time when the one or more configuration settings were stored.

7. The method of claim 1, wherein the one or more configuration settings are stored with a device identifier identifying the customer premises device associated with the one or more configuration settings.

8. The method of claim 1, wherein the one or more configuration settings associated with the at least one of the user or the customer premises are periodically stored on a local storage device or remote storage device.

9. The method of claim 1, wherein the request to reset the customer premises device is received via a reset signal generated by a hardware button located on the customer premises device.

10. The method of claim 9, wherein the hardware button is a factory reset button located on the customer premises device.

11. The method of claim 1, further comprising:
determining, with the customer premises device, whether an outage in a network has occurred; and
based on a determination that the outage in the network has occurred, storing, with the customer premises device, the one or more configuration settings associated with the at least one of the user or the customer premises.

12. The method of claim 1, further comprising:
determining, with the customer premises device, whether the one or more configuration settings associated with the at least one of the user or the customer premises have been changed; and
based on a determination that the one or more configuration settings associated with the at least one of the user or the customer premises have been changed, storing, with the customer premises device, the one or more changed configuration settings associated with the at least one of the user or the customer premises.

13. The method of claim 1, further comprising:
in response to receiving the request to reset the customer premises device, checking for a network connection between the customer premises device and a service provider network;
based on a determination that the network connection exists between the customer premises device and the service provider network, storing the one or more configuration settings in a remote storage located in the service provider network; and
based on a determination that the network connection does not exist between the customer premises device and the service provider network, storing the one or more configuration settings in a local storage of the customer premises device.

14. The method of claim 1, further comprising:
in response to receiving the request to reset the customer premises device, displaying, with the customer premises device, the one or more configuration settings associated with the at least one of the user or the customer premises;
receiving, with the customer premises device, a selection from the user of the one or more configuration settings; and
configuring, with the customer premises device, the customer premises device with the one or more configuration settings selected by the user.

15. The method of claim 14, wherein the one or more configuration settings are displayed in a list, and wherein the list comprises at least one of one or more most recent configuration setting, one or more prior configuration settings, or one or more factory default settings.

16. An apparatus, comprising:
at least one processor; and
a non-transitory computer readable medium communicatively coupled to the at least one processor, the non-transitory computer readable medium having stored thereon computer software comprising a set of instructions that, when executed by the at least one processor, causes the apparatus to:
receive a request to reset a customer premises device;
in response to receiving the request to reset the customer premises device, store one or more configuration settings associated with the at least one of a user or a customer premises of the customer premises device;
reset the customer premises device;
in response to resetting the customer premises device, retrieving the one or more configuration settings associated with at least one of the user or the customer premises, wherein the one or more settings associated with at least one of the user or the customer premises are different from one or more factory settings associated with the customer premises device; and
configure the customer premises device with the one or more configuration settings associated with the at least one of the user or the customer premises.

17. The apparatus of claim 16, wherein the customer premises device comprises at least one of a modem, an optical network terminal, a set-top box, a gateway device, a media player, a gaming console, a camera, a sensor, a thermostat, a desktop computer, or a laptop computer.

18. The apparatus of claim 16, wherein the one or more configuration settings comprise at least one of one or more local area network settings, one or more wide area network settings, one or more service set identifiers, one or more login credentials, one or more Internet protocol (“IP”) addresses, one or more domain names, one or more security settings, one or more remote management settings, one or more encryption types, one or more frequency settings, one or more blocked addresses, one or more permitted addresses, one or more calibration settings, or one or more display settings.

19. A system comprising:
a customer premises device, comprising:
at least one first processor; and
a first non-transitory computer readable medium communicatively coupled to the at least one first processor, the first non-transitory computer readable medium having stored thereon computer software comprising a first set of instructions that, when executed by the at least one first processor, causes the first customer premises device to:
receive a request to reset the customer premises device;
in response to receiving the request to reset the customer premises device, store one or more configuration settings associated with the at least one of a user or a customer premises of the customer premises device;
resetting the customer premises device;
in response to resetting the customer premises device, retrieving the one or more configuration settings associated with at least one of the user or the customer premises, wherein the one or more settings associated with at least one of the user or the customer premises are different from one or more factory settings associated with the customer premises device; and
configuring the customer premises device with the one or more configuration settings associated with the at least one of the user or the customer premises.

20. The system of claim 19, wherein the customer premises device comprises at least one of a modem, an optical network terminal, a set-top box, a gateway device, a media player, a gaming console, a camera, a sensor, a thermostat, a desktop computer, or a laptop computer.
